(19) United States
(12) Patent Application Publication
(10) Pub. No.: US 2009/0210351 A1
(43) Pub. Date: Aug. 20, 2009

(54) System and Method for Minimizing Redundant Meetings

(76) Inventors: Christopher L. Bush, Austin, TX (US); Didier L. Garcia, Miami, FL (US); Joshua F. Nedelka, Meriden, CT (US); Mark Rutenburg, Durham, NC (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(21) Appl. No.: 12/031,745

(22) Filed: Feb. 15, 2008

(51) Int. Cl. G06Q 10/00

(52) U.S. Cl. 705/80

(57) ABSTRACT

A system and method for minimizing redundant events/meetings is provided. With the system and method, when a meeting request is made, a search of meetings currently in place for the participants involved in the meeting is performed to find potential matches and patterns between them. If a potential match is found, a notification is sent to request that participants join in on a matching currently existing meeting. If that request is declined, a meeting time close to the found meeting is recommended so that preparation time is minimized for these meetings as the preparation has already been completed for the previous meeting. Not only will this maximize the amount of work time people have, it will increase the size of the community that is present within meetings. This will allow for larger collaboration between different, potentially unrelated, parties interested in the meeting topic.

### BACKGROUND

1. Technical Field

The present application relates generally to an improved data processing system and method. More specifically, the present application is directed to a system and method for minimizing redundant meetings.

2. Description of Related Art

Many different types of software have been developed for organizing individual's electronic communications, calendars of events, and other personal information. By far the most prominently used of this software is Lotus Notes™, available from International Business Machines (IBM) Corporation of Armonk, N.Y., and Outlook™, available from Microsoft Corporation. IBM's Lotus Notes is a software suite that provides an integrated personal information management desktop client for accessing electronic mail (email), electronic calendars, and applications on an IBM Lotus Domino™ server. The Lotus Notes™ client is mainly used as an email client but also acts as an instant messaging client (for Lotus Sametime™), an Internet browser application, a notebook application, and a calendar/resource reservation application client. The Lotus Notes™ client may also be used as a platform for interacting with collaborative applications.

The Lotus Notes™ client can be used as an IMAP and POP email client with non-Lotus Domino™ email servers. Recipient addresses can be retrieved from any Lightweight Directory Access Protocol (LDAP) server. The Lotus Notes™ client also does web browsing although most people configure it to launch their default browser instead.

Features of Lotus Notes™ include group calendaring and scheduling, SMTP-based email (HTML based email is available to Java developers), NNTP-based news support, and automatic HTML conversion of all documents by the Domino HTTP task. Lotus Notes™ instant messaging (Lotus Sametime™) allows one to see coworkers online and have chat sessions with them. A chat session can be with one person or multiple people (an instant meeting). A design client is available to allow rapid development of databases consisting of forms, which allow users to create documents; and views, which display selected document fields in columns.

Microsoft Outlook™ is a personal information manager from Microsoft, and is part of the Microsoft Office suite. Similar to IBM's Lotus Notes™, Microsoft Outlook™ allows users to access and organize electronic mail communications, calendars, tasks, and the like. Via Microsoft Outlook, as with IBM Lotus Notes, individuals may be invited to calendar events, such as meetings, using an electronic mail messaging functionality and have their calendars synchronized with regard to these calendar events. In addition, a user may add calendar events for only that user. These calendar events may be provided to a user via a graphical user interface of one or more levels of granularity. Functionality is provided for detecting conflicts in calendar events when establishing one of the calendar events and notifying a user of the conflicts in calendar events.

Many different types of improvements have been made to electronic personal calendar applications and functionalities, such as those provided by IBM and Microsoft. For example, U.S. Pat. No. 5,050,077 discloses a method of scheduling a meeting among terminal users who are provided with calendaring applications for storing and retrieving times and dated events. A prompting screen is presented to a meeting scheduler with blanks for keying in desired times, dates, and prospective attendees for a meeting. In response to the scheduler keying to this screen, a comparison is made with the calendar of events for each prospective attendee. As a result of the nonavailability of a meeting time which complies with the desired times, dates, and attendees, certain of these factors are automatically altered or relaxed in order to achieve an acceptable meeting time. An option list of meeting times is then presented to the scheduler for selection of a meeting time. Based upon the selection of the scheduler, a meeting notification screen is then constructed for transmittal to each attendee.

U.S. Pat. No. 5,093,901 discloses a method of exchanging entries on calendars being maintained by a first and a second calendar user. An event is automatically scheduled on a second calendar if a classification which is associated with the event is higher than any previous scheduled event for the same time slot. A reply is prepared and transmitted to the first calendar user which requested the scheduling of the event regarding the status of the second user in regards to the scheduled event. Subsequently, if the status of the second user changes in regards to the event, a subsequent reply is prepared and transmitted to the first user setting forth the changed status.

U.S. Pat. No. 5,774,867 discloses a method and apparatus for camping on an electronic calendar. In one embodiment the method and apparatus determine, in response to an input of a date, a time, and a duration of a proposed meeting between meeting requester and a target, that a conflicting event appears on the target's electronic calendar. The method and apparatus monitor the target's electronic calendar to detect the removal of the conflicting event and schedules a meeting between the requester and the target on their electronic calendars in response to the detection of the removal of the conflicting event.

U.S. Pat. No. 5,890,134 discloses a schedule optimizing algorithm scheduling quality, reducing a schedule cycle time and requiring only marginal increase in computer execution time. Lower quality computerized scheduling programs are substantially improved through the additional steps of sequential left time shifting and right time shifting of respective chronologically sorted completion time and starting time task listings.

U.S. Pat. No. 5,963,913 discloses a system and method for scheduling an event subject to the availability of requested participants. A server application receives event information submitted by a scheduler using a client application to access an event definition page. The event information provides one or more options for scheduling an event and lists a plurality of requested participants. Responsive to receiving the event information, the server application creates an event reply page and an event confirmation page. The server application then creates and sends an electronic mail message to each requested participant to provide information about the one or more options and a link to the event reply page. The server application also creates and sends a message to the scheduler to provide a link to the event confirmation page. The server application then receives reply information submitted by the requested participants using client applications to access the event reply page. The server application processes this reply information together with the original event information to generate one or more potential schedules and then updates the event confirmation page based upon the potential schedules. The server application receives an event confirmation submitted by the scheduler using a client application to access the event confirmation page and then creates and sends a message to each available participant to provide the schedule for the event.

U.S. Pat. No. 6,101,480 discloses a system for scheduling time intervals for a plurality of users on a network comprised database system that stores a profile for each potential invitee of the system at one or more servers. The invitee profiles comprises user profiles wherein each user profile has information regarding available and unavailable times for that user. The system further comprises request generators located remotely from the server and connected over a network that generates a request for allocation of a time interval for one or more of the plurality of invitees. A busy time determination device gathers the profiles for the one or more requested invitees that are available in the database and determining whether those invitees are available during the time interval requested by the request generating means. If not all invitees are available, a best fit determination system determines a next best time interval.

Most recently, IBM has developed an improvement upon calendar applications in which automated meeting insertion and rescheduling for busy calendars is provided. This improvement is described in commonly owned U.S. Pat. No. 7,283,970. As described therein, an electronic calendar meeting scheduler stores meeting automation properties defined for each scheduled meeting. The electronic calendar meeting scheduling program identifies a solution time block for automated meeting insertion and rescheduling utilizing stored meeting automation properties. An electronic calendar meeting scheduling program utilizes stored meeting automation properties to change each conflicting scheduled meeting for the identified solution time block for the automated meeting insertion and rescheduling.

The electronic calendar meeting scheduling program stores meeting attendee automation properties defined for each attendee of each scheduled meeting. The electronic calendar meeting scheduling program utilizes the stored meeting automation properties to calculate a conflict score and action list for each potential time block for automated meeting insertion and rescheduling. The stored meeting attendee automation properties also can be used with the stored meeting automation properties to calculate the conflict score and action list for each potential time block for automated meeting insertion and rescheduling. The action list includes an entry for each conflicting meeting for automated meeting insertion and rescheduling. The electronic calendar meeting scheduling program utilizes the calculated conflict score and action list of the potential time blocks to identify a solution time block for automated meeting insertion and rescheduling.

The meeting automation properties defined for each scheduled meeting include a move premium value for moving the meeting, a shorten premium value for shortening the meeting and a leave premium value for allowing attendees to leave the meeting early. Both the meeting automation properties and the meeting attendee automation properties include multiple approval options for moving the meeting, for shortening the meeting and for allowing attendees to leave the meeting early. The meeting attendee automation properties include an attendee role for each attendee of each the scheduled meeting, such as owner, presenter, observer and collaborator. The meeting attendee automation properties include attendee commitment option for attending, and attendee selected notification options. The calculated conflict score and action list for each potential time block for rescheduling a meeting are based upon multiple factors including a move score, a leave early score, and a shorten meeting score.

### SUMMARY

A reoccurring problem in the workplace is the scheduling of redundant events, such as redundant meetings of individuals within the workplace with other individuals either within or outside the workplace. Many times, especially with developers of products, multiple people want to see the same demonstration or presentation within a very short amount of time. This reduces the amount of time people have to do the work they need to do, as they are either preparing again for the same meeting they gave previously, or are spending their time giving that meeting again. Standard electronic calendar and event/meeting creation systems do not provide any functionality for addressing this problem.

For example, while there are a number of innovations in the area of electronic calendars and event scheduling, none of these innovations actually look to the content of the events when determining how to schedule them using the electronic calendar. That is, the known mechanisms typically only look to see if times of events conflict without taking into account the actual content of the events when determining an optimum time for scheduling a new meeting. Moreover, the known mechanisms fail to integrated two or more separate events into a single event based on the content of the events.

The illustrative embodiments provide a system and method for minimizing redundant meetings. The system and method of the illustrative embodiments may be used on conjunction with a calendar functionality of a personal information management application, such as IBM Lotus Notes™ or Microsoft Outlook™, for example. With the system and method of the illustrative embodiments, when a meeting request is made, a search on the meetings currently in place for the main parties involved in the meeting is performed to find potential matches and patterns between the existing meetings and a new meeting to be scheduled. If a potential match is found, a notification is sent to request that person or party to join in on a currently existing meeting. If that request is declined, a meeting time very close to the found meeting is recommended so that preparation time is minimized for these meetings as the preparation has already been completed for the other meeting. Not only will consolidating meetings or scheduling a new meeting very close to the found meeting maximize the amount of work time people have, it will increase the size of the community that is present within meetings. Such consolidation and/or close proximity scheduling will allow for larger collaboration between different, potentially unrelated, parties interested in the meeting topic.

With the mechanisms of the illustrative embodiments, an electronic calendar and meeting creation system is provided in which fields are provided for specifying subject, meeting time, duration, invitee addresses, location information, category type, and the like. In addition to these fields, one or more fields are present for providing a meeting description. Moreover, a functionality is provided for allowing the creator and/or invitees the ability to add tags to the meeting data structure and edit the meeting description.

When creating a meeting, a user may enter a subject, description, invitee addresses, a desired time and duration, and an initial set of categories and/or tags. When the meeting is submitted, a search will be done on the meetings of the invitee's electronic calendars, such as via a centralized server or a distributed mechanism. If the initial tags and/or keywords of the description match the tags/description of one or more already established meetings on the invitees' calendars within a predetermined threshold, a notification may be sent to the meeting creator with the description and/or tags of the found meeting, giving them the option to either request to be added to the currently existing meeting or to change their time to be as close as possible to that meeting. If, for instance, some of the invitees of the meeting have conflicts with the currently existing meeting, the meeting system may find a time that every invitee has that is as close as possible to the currently existing meeting by interfacing with the various calendars of the invitees' computing devices to determine an optimum time for consolidating the new meeting with the currently existing meeting.

In one illustrative embodiment, a method for consolidating events having similar content in an electronic calendar is provided. The method may comprise receiving a request to schedule a new event in the electronic calendar, wherein the request specifies characteristics of the new event, the characteristics being representative of content of the new event and performing a search of event characteristics to identify existing events in the electronic calendar based on the characteristics of the new event and the characteristics of the existing events. The method may further comprise, in response to identifying at least one similar existing event, negotiating consolidation of the new event with the at least one similar existing event into a single consolidated event in the electronic calendar. The consolidated event may be stored in the electronic calendar in place of at least one of the new event and the at least one similar existing event.

The new event may be a meeting having as participants an originator of the new event and at least one invitee. Performing a search of event characteristics to identify existing events may be performed on electronic calendars on at least one computing device associated with each participant of the new event. Performing a search of event characteristics to identify existing events comprises at least one of sending a request, to computing devices associated with each participant in the new event from a computing device associated with the originator of the new event request, that each of the computing devices associated with each participant perform a search of event characteristics for existing events in a local electronic calendar data structure, or sending a request to a central server computing device requesting a search, of event characteristics for existing events, in participant calendar data structures maintained by the server computing device.

Performing a search of event characteristics to identify existing events in the electronic calendar based on the characteristics of the new event and the characteristics of the existing events may comprise identifying a first candidate set of existing events having a category characteristic matching a category characteristic of the new event. A second candidate set of existing events may be identified from the first candidate set, the second candidate set of existing events having one or more tag characteristics matching one or more tag characteristics of the new event. Moreover, performing a search of event characteristics to identify existing events in the electronic calendar based on the characteristics of the new event and the characteristics of the existing events may further comprise calculating a score for each of the existing events in the second candidate set of existing events based on a degree of matching for the one or more tag characteristics of the existing events to the one or more tag characteristics of the new event.

A highest scoring existing event may be identified as an existing event in the second candidate set having a highest score. Negotiating consolidation of the new event with the at least one similar existing event into a single consolidated event in the electronic calendar may be performed with regard to the identified highest scoring existing event.

Negotiating consolidation of the new event with the at least one similar existing event into a single consolidated event in the electronic calendar may comprise providing an output to a user via a user interface, the output identifying the at least one similar existing event and providing an output to the user via the user interface identifying one or more selectable options for selecting a process for performing the negotiation of consolidation of the new event with the at least one similar existing event. A user selection of an option in the one or more selectable options may be received and the negotiation of the consolidation of the new event may be performed with the at least one similar existing event in accordance with the user selected option.

Negotiating consolidation of the new event with the at least one similar existing event into a single consolidated event in the electronic calendar may comprise sending a request to an originator of the at least one similar existing event requesting that participants in the new event be added as participants in the at least one similar existing event and receiving a response from the originator of the at least one similar existing event. The characteristics of the new event may be updated to correspond with the characteristics of the at least one similar existing event if the originator of the at least one similar existing event accepts addition of the participants of the new event as participants in the at least one similar existing event. Negotiating consolidation of the new event with the at least one similar existing event into a single consolidated event in the electronic calendar may further comprise scheduling the new event in response to the originator of the at least one similar existing event refusing addition of the participants of the new event as participants of the at least one similar event. Scheduling the new event may further comprise determining a time and duration for the new event that is as close to the at least one similar existing event as possible given electronic calendar entries of the electronic calendars of the participants in the new event.

Negotiating consolidation of the new event with the at least one similar existing event into a single consolidated event in the electronic calendar may further comprise sending one or more requests to computing devices associated with one or more participants of the at least one similar existing event requesting a change in characteristics of the at least one similar existing event based on characteristics of the new event. Characteristics of at least one of the new event and the at least one similar existing event may be updated based on responses received from computing devices associated with the one or more participants.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary representation of an exemplary distributed data processing system in which aspects of the illustrative embodiments may be implemented;

FIG. 2 is a block diagram of an exemplary data processing system in which aspects of the illustrative embodiments may be implemented;

FIG. 3 is an exemplary block diagram of an electronic calendar and event scheduling system in accordance with one illustrative embodiment;

FIG. 4 is an exemplary diagram of a user interface for generating a new meeting event in accordance with one illustrative embodiment;

FIG. 5 is an exemplary diagram of a user interface for specifying the options for a user to minimize redundant meetings in accordance with one illustrative embodiment; and

FIG. 6 is a flowchart outlining an exemplary operation for scheduling an event in accordance with one illustrative embodiment.

### DETAILED DESCRIPTION OF THE ILLUSTRATIVE EMBODIMENTS

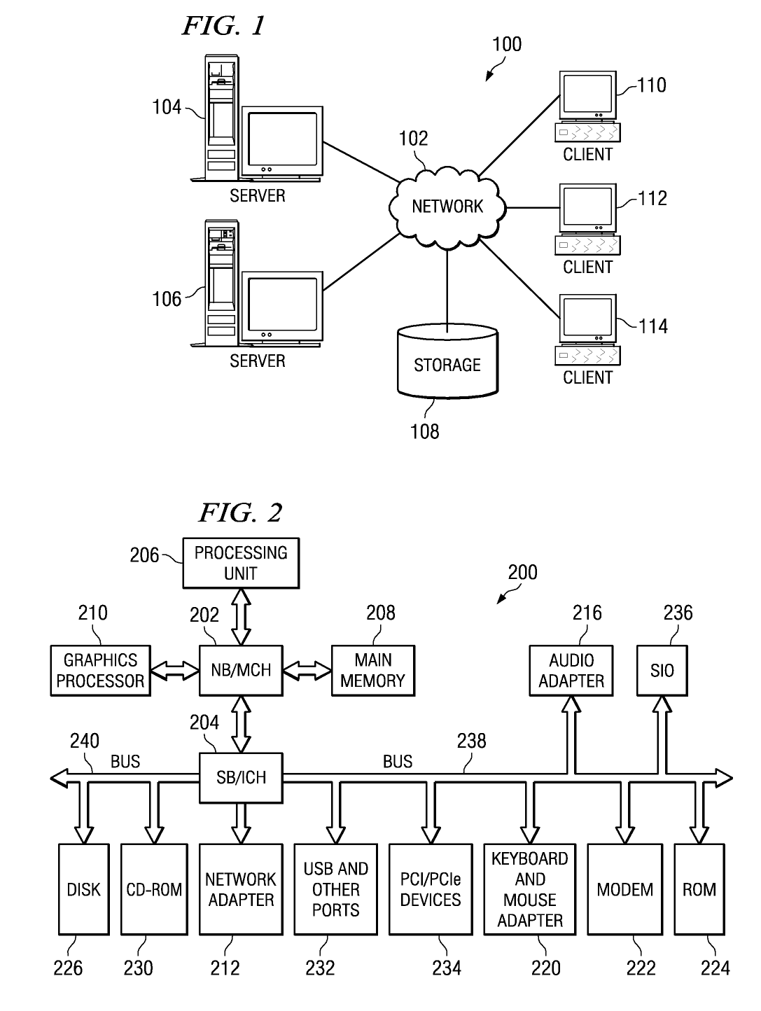

The illustrative embodiments provide a system and method for minimizing the scheduling of redundant meetings. As such, the illustrative embodiments are especially well suited for implementation in a distributed data processing environment in which multiple client computing devices communicate with one or more server computing devices via one or more data networks. In order to provide a context for the following description of the specific elements of the illustrative embodiments, FIGS. 1-2 are provided hereafter as exemplary diagrams of data processing environments in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as hosts 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

Returning to FIG. 1, assume that a user of a first client computing device 110 wishes to schedule an event, such as a meeting to discuss a particular topic, with a user of a second client computing device 112. For the purposes of the description of the illustrative embodiments, it will be assumed that the event in question is a meeting of individuals, such as persons in a workplace, to discuss a particular topic. However, it should be appreciated that the illustrative embodiments are not limited to any particular type of event and may be used with any event for which minimization of redundant events is desired.

With the mechanisms of the illustrative embodiments, the user of the first client computing device 110 may generate an event data structure specifying information in fields for a subject of the meeting, a suggested meeting time, a duration of the meeting, invitee addresses, e.g., an email address of the user of the second client computing device 112, a suggested location for the meeting, one or more category types for the meeting, and the like. In addition to these fields, one or more fields are present for providing a meeting description. Moreover, a functionality is provided for allowing the creator and/or invitees the ability to add tags to the meeting data structure and edit the meeting description.

In response to the user of the first client computing device 110 selecting a store or save functionality, such as via a graphical user interface element of an electronic calendar and/or personal information management application, the mechanisms of the illustrative embodiments access and analyze the already existing events in the user's calendar data structure. In addition, the mechanisms of the illustrative embodiments send one or more requests to either a server or the other client computing devices 112 associated with the invitee addresses specified by the user. Such a request may specify the particular characteristics of the meeting that is intended to be scheduled. In one illustrative embodiment, a centralized server, or set of servers, such as server 104, maintains calendar data structures for each of the users of client computing devices associated with the server, such as in an enterprise computing system or the like. In other illustrative embodiments, the functionality of the illustrative embodiments is distributed across the client computing devices 110-114 such that each client computing device executes an electronic calendar and personal information management application that may interact with similar applications on the other client computing devices to facilitate scheduling of events and minimization of redundant events.

In response to receiving a request for scheduling the meeting from the first client computing device 110, the server 104 or second client computing device 112, depending upon the implementation, may perform a search on the calendar data structure for the user specified by the invitee address, i.e. the second user. The search may be performed using any of a number of different characteristic items indicative of the content of the meeting. For example, in one illustrative embodiment, the categories associated with the new meeting to be scheduled may be compared to categories of meetings already having been scheduled in the second user's calendar data structure to identify a first set of candidate meetings. This first set of candidate meetings may then be analyzed to compare tags associated with the new meeting to be scheduled with tags associated with the meetings in the first set of candidate meetings.

The tags associated with meetings may take many different forms and may identify different types of information indicative of the content of the meeting. For example, the tags may include keywords associated with the description of the meeting, various topic category identifiers, subject matter indices, or any other alphanumeric representation of information indicative of the content of the associated meeting that may be recognizable for comparison by the mechanisms of the illustrative embodiments to identify events, e.g., meetings, that have similar subject matter, content, topics, or the like. Moreover, the tags may be selected, upon origination of the meeting or in response to an invitee editing the tags, from a set of pre-approved tags for specifying content of meetings, such as organizational codes, project identifiers, level of the intended discussion, e.g., introduction, moderate, expert, etc. Alternatively, the tags may be entered in a free-form manner, i.e. not selected from a predefined listing, but correlation with other similar tags may not be as easy to determine in such an implementation and more comprehensive comparisons may be required for identifying tags that may not be quite the same but yet related. With such embodiments, various data structures may be utilized for identifying similar terms, including thesaurus, dictionaries, organizational chart data structures, and the like.

Based on the matching tags and categories, a score for the relative matches of an existing meeting with that of the new meeting to be scheduled may be generated. Each of the existing meetings' scores may be compared against one or more thresholds to determine if they are sufficiently similar to the new meeting to be scheduled to initiate further processing for minimizing redundant meetings. A highest scoring meeting that satisfies the one or more thresholds, i.e. a closest match, may then be used as a basis for further processing for scheduling the new meeting in accordance with the mechanisms of the illustrative embodiments.

This additional processing may involve providing a response to the first client computing device 110 indicating the presence of another meeting having sufficiently similar content and providing the first user of the first client computing device 110 with options for minimizing redundant meetings. For example, options may be presented to the first user for sending a request to the originator of the existing meeting that the first user be added as a participant in the meeting. This option may be presented only if the first user does not already have an event in their electronic calendar that conflicts with the timing and duration of the existing meeting. Alternatively, if there is a conflict, this option may still be presented but with a flag or indicator informing the user of the conflict and indicating that other events may need to be rescheduled.

The originator of the existing meeting may then choose whether or not to include the first user as a participant in the existing meeting. If the originator chooses to include the first participants, the new meeting data structure is updated accordingly to change the characteristics of the new meeting data structure to match those of the existing meeting. Moreover, the existing meeting data structures may also be updated to include the first user as a participant. It should be appreciated that these operations may be performed for the first user as well as any other invitees specified in the original new meeting data structure such that all intended participants in the new meeting are added to the existing meeting as participants.

If the originator of the existing meeting chooses to not add the first user as a participant for one reason or another, the first user may then be permitted to go forward with scheduling the new meeting as if the existing meeting were not found in the first place. As a result, the new meeting may be generated in a manner generally known in the art and invitees may be invited to the meeting in this generally known manner. While in this case a potentially redundant meeting may be scheduled, it is anticipated that such cases will be rarely encountered with the mechanisms of the illustrative embodiments.

In generating the new meeting, the generally known mechanisms may be modified by the mechanisms of the illustrative embodiment to determine a time and duration that is as close to the existing meeting as possible given the calendar entries of the electronic calendars of the various invitees to the new meeting. That is, the time and duration of the new meeting may be adjusted so as to minimize the time between the existing meeting and the new meeting. This adjustment may be performed by looking at the already existing events in the first user's electronic calendar to determine a time and duration as close to the existing meeting as possible without causing a conflict with an existing event. This time and duration may be used to update the original new meeting data structure before sending invitations out to each of the invitees. As a result, the time for preparation for the new meeting may be minimized since the content of the meeting should be fresh in the mind of the presenter(s) of the existing meeting and thus, additional time for preparation may be avoided.

As another option, the first user may be provided with the option to contact each of the participants, i.e. any invitees and the presenter(s), in the existing meeting to attempt to negotiate a different time, duration, location, etc., for the existing meeting that is as close to the meeting time, duration, location, etc. of the existing meeting as possible but taking into account the events in the electronic calendars of the first user and invitees of the new meeting to be scheduled. Information about the other participants in the existing meeting may be returned with the response from the server 104 or client computing device 112 indicating the presence of an existing meeting that is sufficiently close enough in content with the new meeting.

In some cases, the time, duration, location, etc. of the existing meeting will not conflict with the events in the electronic calendars of the first user and invitees to the new meeting. In such a case, a request may simply be made to the originator of the existing meeting requesting that the first user and the invitees to the new meeting be added as participants to the existing meeting. Data structures for the new meeting and existing meeting may be updated accordingly, as discussed previously above.

In other cases, the time, duration, location, etc., of the existing meeting may conflict with one or more events in the electronic calendars of the first user and/or one or more invitees to the new meeting. In such a case, a mechanism for negotiating a new time for the existing meeting and the new meeting as a single event may be performed. This negotiation mechanism may take many different forms depending upon the desired implementation. For example, the negotiation mechanism may provide an engine that implements a simple set of transactions in which a proposal is made, either an acceptance or a rejection is returned, the rejection may be accompanied with a counter-proposal, and the process may be repeated with the counter-proposal either being accepted or rejected. Alternatively, a more complex negotiation mechanism, such as the one described in commonly owned U.S. Pat. No. 7,283,970, for example, may be utilized by the illustrative embodiments. Of course other negotiation mechanisms may be used for negotiating a new time and duration for the existing meeting and new meeting without departing from the spirit and scope of the present invention. Eventually, either a new time and duration for the existing and new meetings may be determined or after a number of proposals and counter-proposals, a determination may be made that a new time for the existing and new meetings cannot be established.

If a new time and duration, location, etc. are established through such a negotiation, the new meeting data structure may be updated appropriately to include the characteristics of the negotiated meeting. Moreover, the characteristics of the existing meeting may be updated appropriately and updates may be communicated to each of the participants in the existing meeting so that all participants have the same information for the established meeting. In this way, new meetings that have sufficiently similar content as an existing meeting may be merged or combined with the existing meeting so as to minimize time expended on preparing for and conducting redundant meetings.

It should be noted that the above description utilizes an embodiment in which categories and tags are used to identify matching events or meetings. However, the illustrative embodiments are not limited to such mechanisms. To the contrary, other indicators of content of an event or meeting may be used to identify matching events or meetings without departing from the spirit and scope of the present invention. For example, in one illustrative embodiment, a keyword extraction mechanism may be provided for extracting keywords from the description of the event or meeting entered by the user when establishing the new meeting data structure. These keywords may be used as a basis for searching the keywords or descriptions of other existing events in the same user or invitees' calendar data structures to identify those that have matching keywords. The number of matching keywords, as well as other characteristics, may be used as a basis for generating a score for each of the events identified. As with the embodiments described above, this score may be compared with one or more thresholds to identify which event(s) to perform further processing for minimizing redundant events/meetings.

Moreover, the above description sets forth different embodiments for consolidating meetings having similar content into as few meetings as possible scheduled as close together as possible. These different embodiments are described with negotiations being performed between the first user and the originator of an existing meeting that is the highest ranking meeting from the determined set of candidates. However, the illustrative embodiments are not limited to such mechanisms. To the contrary, any number of candidate events/meetings may be selected for use in reducing the number of redundant events/meetings. It should be appreciated that this same set of operations and functionalities may be used with each originator of each event/meeting that is being consolidated. Thus, many different events/meetings may be consolidated into a single meeting that minimizes the redundancy of the meetings overall.

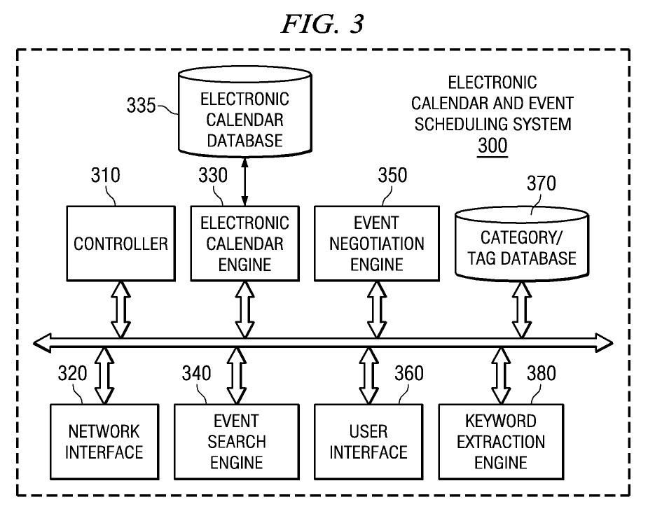

FIG. 3 is an exemplary block diagram of an electronic calendar and event scheduling system in accordance with one illustrative embodiment. As shown in FIG. 3, the system 300 includes a controller 310, a network interface 320, an electronic calendar engine 330 which also either stores or has an interface to an electronic calendar database 335, an event search engine 340, an event negotiation engine 350, a user interface 360, a category/tag database 370, and a keyword extraction engine 380. The elements 310-380 may be implemented in hardware, software, or any combination of hardware and software. In one illustrative embodiment, the elements 310-380 are implemented as software instructions executed by one or more data processing devices.

The controller 310 controls the overall operation of the system 300 and orchestrates the operation of the other elements 320-380. In a distributed data processing environment embodiment, the network interface 320 provides a communication path through which data may be sent and received. For example, requests for establishing a new event/meeting may be received from a client computing device via the network interface 320, user interfaces for entry of information for events/meetings may be sent to the client computing device via the network interface 320, information identifying matching events/meetings may be communicated to the client computing device via the network interface 320, etc. Alternatively, if the system 300 is implemented on the client computing device itself, such interaction may be performed through a user interface 360.

The electronic calendar engine 330 provides the logic and functionality for creating, editing, and storing events/meetings in an electronic calendar for one or more users. In an embodiment in which one or more centralized servers are used to store the electronic calendar information for a plurality of users, the electronic calendar engine 330 may support multiple electronic calendars for the plurality of users. However, for purposes of the present description, it will be assumed that the electronic calendar engine 330 operates for a single user of a single computing device, such as in an illustrative embodiment in which the system 300 is deployed on a client computing device, in order to simplify the description.

The electronic calendar engine 330 further either stores or provides an interface to the electronic calendar database 335. The electronic calendar database 335 stores information regarding the various events/meetings already established in the calendar associated with the user of the computing device. This information may include, for example, names of the events/meetings, subjects, times, durations, descriptions, categories, tags, etc. that describe the event/meeting, collectively referred to as the event/meeting characteristics. This information may be used with requests from other client computing devices in order to perform searches for matching existing events/meetings. Moreover, this information may be updated in response to negotiations for new event/meeting characteristics or in response to adding one or more participants to the events/meetings.

The event search engine 340 provides the logic and functionality for extracting search information from a new meeting data structure and logic/functionality for performing searches of events/meetings existing in the electronic calendar database 335, via the electronic calendar engine 330, as well as sending out requests for searches to be performed on other client computing devices via the network interface 320. As discussed above, the new meeting data structure may store all of the characteristic information for a proposed new meeting to be scheduled in the electronic calendar database 335 as well as other invitees' electronic calendars. This information may include category designations for specifying a category of the event/meeting, tag information identifying tags describing the content of the event/meeting, description information providing a free-form description text of the content of the event/meeting, and the like. From the various event/meeting characteristic information, search information may be extracted for use in performing a search of similar events/meetings existing in the electronic calendar database 335 and in other client computing devices of invitees to the new meeting.

The searches may identify one or more existing events/meetings that have sufficiently similar content to that of the proposed new meeting. Such a determination may be made, for example, by comparing one or more of the categories, tags, extracted keywords, and other event/meeting characteristic information of the new meeting with event/meeting characteristic information of existing events/meetings in the electronic calendar database 335 and electronic calendars of the other client computing devices. Based on the degree of matching, various scores for the amount of matching may be generated and used as a basis to compare against one or more thresholds. The thresholds may be user defined and may specify a degree of similarity between the new meeting and existing events/meetings required before consolidation of the events/meetings is considered to be performed. The characteristic information for those existing event/meetings meeting the requirements of the thresholds may be returned to the requestor, e.g., event search engine 340, as results of the search.

The event search engine 340 may receive the results of the searches and may provide the results of the search to a user who requested the establishment of the new meeting either via the network interface 320 or the user interface 360. The results may be presented in a graphical user interface (GUI) manner such that GUI elements are provided for selection by a user for requesting various functionalities of the mechanism of the illustrative embodiment to be performed. For example, a highest ranking matching existing event/meeting may be selected and presented to the user along with options for selecting whether to request to add participants of the new meeting as participants to the existing event/meeting, options to negotiate a new time, duration, location, etc., for the existing event/meeting based on the intended time, duration, location, etc., of the new meeting, store the new meeting without consolidation of meetings, or the like.

If the user selects an option to request addition of the user and other invitees, if any, in the new event/meeting as participants to the existing event/meeting, the event negotiation engine 350 may be employed to send an automatically constructed request to be sent to the address of the originator of the existing event/meeting requesting the addition of the user and other invitees of the new meeting as participants in the existing event/meeting. In response to the originator of the existing event/meeting agreeing to add the user and other invitees of the new event/meeting as participants to the existing event/meeting, the new meeting characteristic information may be automatically modified to match that of the existing event/meeting and appropriate invitations sent out to the invitees of the new meeting (which has now been modified to have the same characteristics as the existing event/meeting). If the originator of the existing event/meeting does not agree to the addition of the user and the invitees, if any, of the new meeting as participants in the existing event/meeting, a negotiation of the new meeting time, duration, location, etc. may be performed to modify the characteristics of the new meeting such that the difference in time between the existing event/meeting and the new meeting is minimized.

If the user selects an option to negotiate a new time, duration, location, etc. of the existing event/meeting, the negotiation engine 350 may further negotiate with the originator of the existing event/meeting and the other participants of the existing event/meeting to obtain new event/meeting characteristics for the existing event/meeting that accommodate the schedules of the participants in the new meeting. In some cases, this may be simply an addition of the participants, e.g., the user and invitees, of the new meeting as participants in the existing event/meeting. In other cases, the time, duration, location, etc. of the existing event/meeting may need to be changed to accommodate the new participants. In such a case, it is desirable to find a time, duration, location, etc., that is as close to the existing event/meeting as possible so as to not inconvenience the participants in the already existing event/meeting, e.g., so that the participants in the already existing event/meeting do not have to adjust their schedules significantly thereby causing scheduling problems for the participants in the already existing event/meeting or cause the presenters to have to prepare for a much earlier event/meeting time, or re-prepare for a much later event/meeting time, than expected.

If it is not possible to be added as a participant to the existing event/meeting, and it is not possible to negotiate new characteristics for the existing event/meeting that accommodate the participants of the new event/meeting, then a redundant event/meeting may be scheduled. Alternatively, the user may select this option without attempting to add participants to the existing event/meeting or negotiate new characteristics for the existing event/meeting. In such a case, a time, duration, location, etc., that is as close to that of the existing event/meeting may be negotiated with the participants of the new event/meeting. This may involve analyzing the events of the electronic calendars of the participants and determining a time, duration, location, etc., that does not conflict with other events/meetings in the electronic calendars but is also as close to those of the existing event/meeting matching the characteristics of the new event/meeting. In this way, the time between redundant events/meetings is minimized which in turn minimizes preparation time for the events/meetings on the part of the presenters since the content of the events/meetings will be fresh in the mind of the presenters.

The category/tag database 370 stores the established categories/tags that may be used to define new events/meetings. These categories/tags provide information in a searchable manner that identifies the content of the event/meeting, the type of event/meeting, the type of participants that are or should be interested in the event/meeting, the subject matter of the event/meeting, and the like. Because these categories/tags are established by the organization with which the client computing devices, server, or the like, are a part, they are consistent across the various data processing devices in the organization's system. Periodic updates of these categories/tags may be provided to the system 300 in order to make sure that the most recent set of acceptable categories/tags are being utilized. Since these categories/tags are standardized within the organization data processing system, they are easily searchable and able to be compared with each other to identify events/meetings having similar content.

The keyword extraction engine 380 is optional and is used in embodiments where keywords may be extracted from free-form descriptions of events/meetings provided when defining the new event/meeting data structure. The keyword extraction engine 380 may identify terms representative of the content or subject matter of the event/meeting for use in performing searches for other similar events/meetings. Such keyword extraction may involve, for example, identifying terms in the descriptions of events/meetings that are not basic terms not indicative of subject matter or topic, such as articles, prepositions, adverbs, adjectives, and the like. These non-basic terms may be further filtered according to a predetermined list of terms deemed to not be of importance to the keyword extraction operation, e.g., nouns and/or verbs that are determined to be more general in nature and not indicative of subject matter or topic. Such a list of terms may be compiled over time, such as with an electronic dictionary or the like. The remaining terms may be used as keywords. Of course, the above is only one possible keyword extraction methodology that may be used by the illustrative embodiments. Many other types of keyword extraction may be used without departing from the spirit and scope of the present invention. For example, any generally known keyword extraction mechanism may be employed by the mechanisms of the illustrative embodiments in order to extract keywords for consolidating events/meetings in the manner of the illustrative embodiments without departing from the spirit and scope of the present invention.

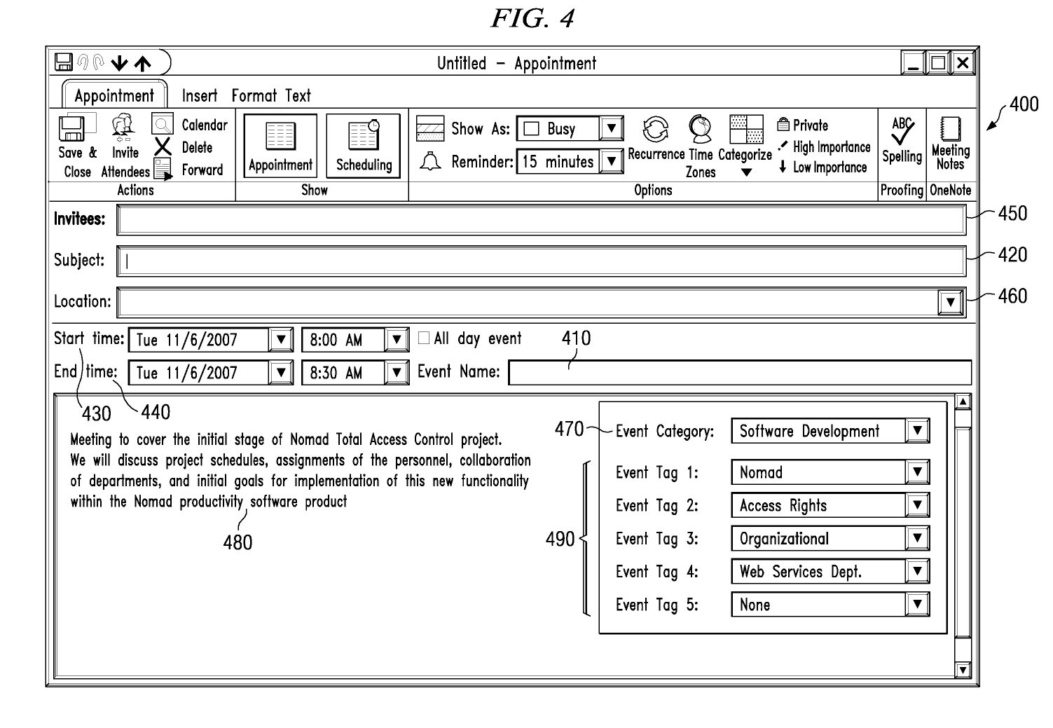

As discussed above, the mechanisms of the illustrative embodiments may provide a number of different user interfaces for defining new events/meetings, selecting options for minimizing redundant meetings, and the like. FIG. 4 is an exemplary diagram of a user interface for generating a new event/meeting in accordance with one illustrative embodiment. The user interface 400 shown in FIG. 4 may be provided to a user via the user's client computing device. For example, the system 300 in FIG. 3 may provide the user interface in response to the user requesting creation of a new meeting.

As shown in FIG. 4, the user interface 400 includes a field 410 for specifying a name of the new meeting, a field 420 for specifying a subject of the meeting, a field 430 for specifying a time for the meeting, a field 440 for specifying a duration of the meeting, a field 450 for specifying addresses of invitees to the meeting, a field 460 for specifying a location of the meeting, and a field 470 for specifying a category type for the meeting. In addition to fields 410-470 a field 480 is provided for allowing a user to enter a free-form textual description of the meeting. Another field 490 is provided for specifying one or more tags for the meeting.

The fields 470 and 490 may be provided as a drop down menu, or the like, for selecting one or more pre-approved and pre-defined categories and tags. For example, various categories may be provided for specifying departments, projects, products, or the like, with which the new meeting is associated. Various tags may be provided for specifying particular sub-topics or specific detailed identifiers of content of the new meeting. In an illustrative embodiment, the categories are a more general representation of the content of the new meeting while the tags provide more specific sub-categories of content. The description entered in the field 480 may be entered as free-form text that may be input by the user using a keyboard or other text entry device.

The information entered into the various fields 410-480 may be used by the mechanisms of the illustrative embodiments to generate search information for searching for existing meetings having similar content. Moreover, the information entered into these fields 410-480 may provide the basis for storing a new meeting in the electronic calendars of users. The new meeting data structures, once added to the electronic calendars may be used in further searches as existing events/meetings. Based on such searches, one or more existing events/meetings that have the same or similar content as a new meeting to be scheduled may be identified. In response to such findings, a user interface may be provided for specifying the existing event/meeting that has a same or similar content as the new meeting that is to be scheduled.

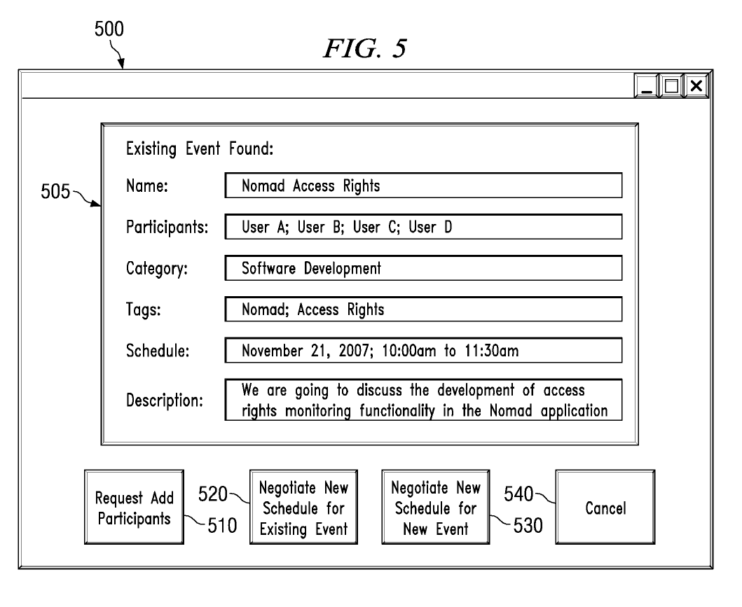

FIG. 5 is an exemplary diagram of a user interface for specifying the options for a user to minimize redundant meetings in accordance with one illustrative embodiment. As shown in FIG. 5, the user interface 500 includes a first portion for specifying characteristics of an existing event/meeting that has a same or similar content as the new meeting that is to be scheduled. In addition, the user interface 500 includes GUI elements 510-540 for selecting options for consolidating meetings or scheduling the new meeting even though it may be somewhat redundant. For example, GUI element 510 is for initiating an operation to request that the intended participants of the new meeting be added to the existing event/meeting. GUI element 520 is for initiating an operation to request negotiation of the characteristics of the existing event/meeting to accommodate the schedules of the participants of the new meeting. GUI element 530 is used to schedule the new meeting as close as possible to the existing event/meeting. GUI element 540 is a cancel element for canceling the functionality of the illustrative embodiments in which case a redundant meeting may be scheduled regardless of the characteristics of the existing event/meeting. These elements may all be selectable by the user to initiate the various functions and operations discussed above.

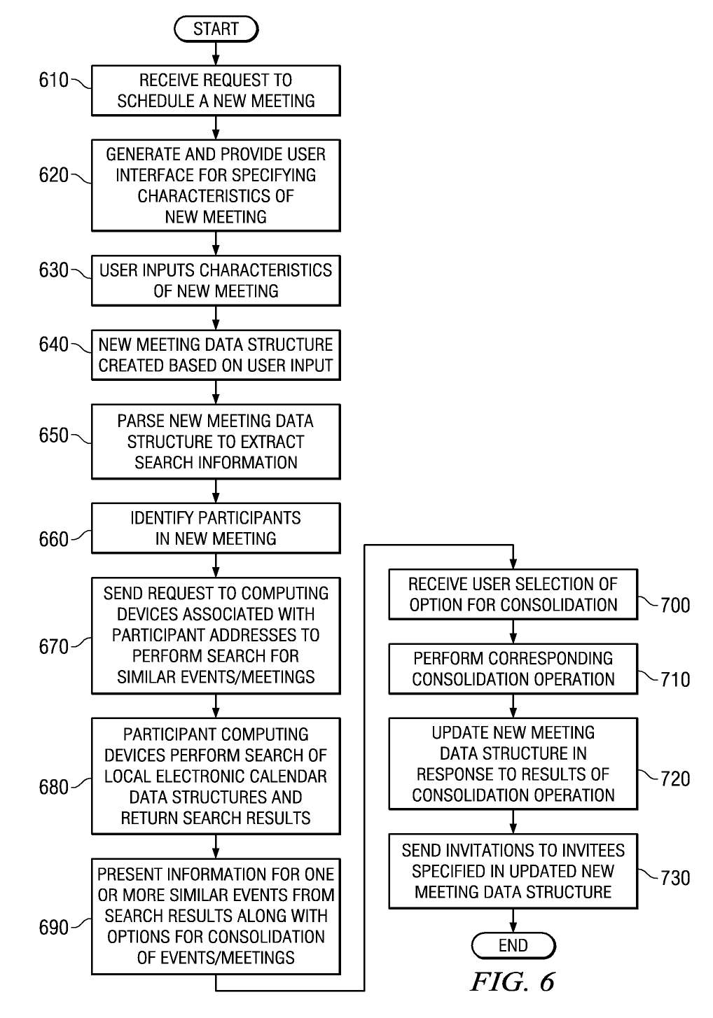

FIG. 6 is a flowchart outlining an exemplary operation for scheduling an event in accordance with one illustrative embodiment. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

Furthermore, the flowchart is provided to demonstrate the operations performed within the illustrative embodiments. The flowchart is not meant to state or imply limitations with regard to the specific operations or, more particularly, the order of the operations. The operations of the flowchart may be modified to suit a particular implementation without departing from the spirit and scope of the present invention.

As shown in FIG. 6, the operation starts with a request to schedule a new meeting being received from a user (step 610). A user interface may be generated and provided to the user for specifying the characteristics of the new meeting (step 620). The user may input the characteristics of the new meeting (step 630) which may then be used to store as a new meeting data structure (step 640). The new meeting data structure may then be parsed to extract search information for performing a search for the same or similar content in existing events/meetings of electronic calendars of one or more of the intended participants of the new meeting, including the originator of the new meeting (step 650). For example, category information, tag information, and/or keyword information may be extracted from the characteristics of the new meeting and used as a basis for comparison against similar characteristics in existing events/meetings of the electronic calendars.

The participants in the new meeting are identified from the characteristics of the new meeting, e.g., their addresses may be extracted from the invitee field of the new meeting user interface (step 660). A request is sent to each of the computing devices associated with the addresses of the participants requesting that a search for similar existing events be conducted and specifying the characteristics extracted from the new meeting data structure (step 670). As discussed above, in one illustrative embodiment, a centralized server based system may be utilized in which all of the electronic calendars of individuals within an organization are stored in a central depository associated with the centralized server and thus, the request may be sent to only this central server which can then perform searches on each of the electronic calendars for the participants in the new meeting. Moreover, in another illustrative embodiment, a single request may be sent to the centralized server which may then orchestrate sending out of requests to each of the client computing devices of the participants of the new meeting. However, for purposes of this description, it will be assumed that a distributed embodiment is being utilized in which each client computing device runs a version of the electronic calendar and personal information management system of the illustrative embodiments.

Each of the computing devices performs a search of their respective electronic calendars for similar events (step 680) and return results of the search to the requesting computing device. As discussed above, such searches may involve comparing the characteristics of the new meeting with those of the existing events to identify a first set of candidate events that have content, e.g., subject matter, topics, etc., that may match the content of the new meeting. This first set of candidate events may have associated scores calculated for them based on the degree of matching of their characteristics with the characteristics of the new meeting. These scores may then be compared to one or more thresholds to identify which ones of the events in the first set of candidate events are most likely to be matches for the new meeting, thereby generating a second set of candidate events. This second set of candidate events may be returned as part of the results of the search returned by the client computing device to the requesting computing device.

One or more options for consolidating the new meeting with one or more of the existing events/meetings may be presented to the user along with information about one or more of the existing events/meetings returned in results from one or more of the client computing devices (step 690). A user selection of an option is received (step 700). Based on the user selection, a corresponding consolidation operation is performed (step 710). As discussed above, these consolidation operations may involve requesting that the participants in the new meeting be added as participants in the one or more existing events/meetings, negotiating new characteristics for the one or more existing events/meetings to accommodate schedules of the participants in the new meeting, negotiating a time for the new meeting that is as close to one or more of the existing events/meetings as possible, and the like.

Based on the results of the performance of the consolidation operation, the new meeting data structure is updated to have the new characteristics, if any, generated based on the consolidation operation (step 720). Appropriate invitations to the participants of the new meeting are sent to their respective addresses specified in the new meeting data structure (step 730). The operation then terminates.

Thus, the illustrative embodiments provide a system and method for minimizing redundant events/meetings in electronic calendars of one or more computing devices. The mechanisms of the illustrative embodiments help in reducing the amount of preparation time required for events/meetings by consolidating events/meetings or scheduling the events/meetings to be in close proximity to each other with regard to time. This will maximize the amount of work time presenters, organizers, and even participants of the events/meetings have since they do not have to spend greater amounts of time preparing for multiple redundant events/meetings

Not only will the illustrative embodiments maximize the amount of work time presenters, organizers, and participants of the events/meetings have, the illustrative embodiments also increase the size of the community that is present within the events/meetings. That is, the mechanisms of the illustrative embodiments consolidate events/meetings that may have participants in a number of different departments, disciplines, locations, etc., such that the resulting group of participants in the consolidated events/meetings is larger and may represent a more diverse set of individuals than previously known event/meeting scheduling mechanisms. Moreover, by increasing the diversity of the individuals participating in events/meetings through consolidation of events/meetings, the illustrative embodiments allow for larger collaboration between different, potentially unrelated, parties interested in the meeting topic.

It should be appreciated that the illustrative embodiments may take the form of a specialized hardware embodiment, a software embodiment that is executed on a computer system having general processing hardware, or an embodiment containing both specialized hardware and software elements that are executed on a computer system having general processing hardware. In one exemplary embodiment, the mechanisms of the illustrative embodiments are implemented in a software product, which may include but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, or semiconductor system, apparatus, or device. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read-only memory (CD-ROM), compact disk-read/write (CD-R/W) and DVD.

The program code of the computer program product may comprise instructions that are stored in a computer readable storage medium in a client or server data processing system. In a client data processing system embodiment, the instructions may have been downloaded over a network from one or more remote data processing systems, such as a server data processing system, a client data processing system, or a plurality of client data processing systems using a peer-to-peer communication methodology. In a server data processing system embodiment, the instructions may be configured for download, or actually downloaded, over a network to a remote data processing system, e.g., a client data processing system, for use in a computer readable storage medium with the remote data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for consolidating events having similar content in an electronic calendar, comprising:
receiving a request to schedule a new event in the electronic calendar, wherein the request specifies characteristics of the new event, the characteristics being representative of content of the new event;
performing a search of event characteristics to identify existing events in the electronic calendar based on the characteristics of the new event and the characteristics of the existing events;
in response to identifying at least one similar existing event, negotiating consolidation of the new event with the at least one similar existing event into a single consolidated event in the electronic calendar; and
storing the consolidated event in the electronic calendar in place of at least one of the new event and the at least one similar existing event.

2. The method of claim 1, wherein the new event is a meeting having as participants an originator of the new event and at least one invitee, and wherein performing a search of event characteristics to identify existing events is performed on electronic calendars on at least one computing device associated with each participant of the new event.

3. The method of claim 2, wherein performing a search of event characteristics to identify existing events comprises at least one of sending a request, to computing devices associated with each participant in the new event from a computing device associated with the originator of the new event request, that each of the computing devices associated with each participant perform a search of event characteristics for existing events in a local electronic calendar data structure, or sending a request to a central server computing device requesting a search, of event characteristics for existing events, in participant calendar data structures maintained by the server computing device.

4. The method of claim 1, wherein performing a search of event characteristics to identify existing events in the electronic calendar based on the characteristics of the new event and the characteristics of the existing events comprises:
identifying a first candidate set of existing events having a category characteristic matching a category characteristic of the new event; and
identifying a second candidate set of existing events from the first candidate set, the second candidate set of existing events having one or more tag characteristics matching one or more tag characteristics of the new event.

5. The method of claim 4, wherein performing a search of event characteristics to identify existing events in the electronic calendar based on the characteristics of the new event and the characteristics of the existing events further comprises:
calculating a score for each of the existing events in the second candidate set of existing events based on a degree of matching for the one or more tag characteristics of the existing events to the one or more tag characteristics of the new event; and
identifying a highest scoring existing event as an existing event in the second candidate set having a highest score, wherein negotiating consolidation of the new event with the at least one similar existing event into a single consolidated event in the electronic calendar is performed with regard to the identified highest scoring existing event.

6. The method of claim 1, wherein negotiating consolidation of the new event with the at least one similar existing event into a single consolidated event in the electronic calendar comprises:
providing an output to a user via a user interface, the output identifying the at least one similar existing event;
providing an output to the user via the user interface identifying one or more selectable options for selecting a process for performing the negotiation of consolidation of the new event with the at least one similar existing event;
receiving a user selection of an option in the one or more selectable options; and
performing the negotiation of the consolidation of the new event with the at least one similar existing event in accordance with the user selected option.

7. The method of claim 1, wherein negotiating consolidation of the new event with the at least one similar existing event into a single consolidated event in the electronic calendar comprises:
sending a request to an originator of the at least one similar existing event requesting that participants in the new event be added as participants in the at least one similar existing event;
receiving a response from the originator of the at least one similar existing event; and
updating the characteristics of the new event to correspond with the characteristics of the at least one similar existing event if the originator of the at least one similar existing event accepts addition of the participants of the new event as participants in the at least one similar existing event.

8. The method of claim 7, wherein negotiating consolidation of the new event with the at least one similar existing event into a single consolidated event in the electronic calendar further comprises:
scheduling the new event in response to the originator of the at least one similar existing event refusing addition of the participants of the new event as participants of the at least one similar event.

9. The method of claim 8, wherein scheduling the new event further comprises:
determining a time and duration for the new event that is as close to the at least one similar existing event as possible given electronic calendar entries of the electronic calendars of the participants in the new event.

10. The method of claim 1, wherein negotiating consolidation of the new event with the at least one similar existing event into a single consolidated event in the electronic calendar further comprises:
sending one or more requests to computing devices associated with one or more participants of the at least one similar existing event requesting a change in characteristics of the at least one similar existing event based on characteristics of the new event; and
updating characteristics of at least one of the new event and the at least one similar existing event based on responses received from computing devices associated with the one or more participants.

11. A computer program product comprising a computer useable medium having a computer readable program, wherein the computer readable program, when executed on a computing device, causes the computing device to:
receive a request to schedule a new event in the electronic calendar, wherein the request specifies characteristics of the new event, the characteristics being representative of content of the new event;
perform a search of event characteristics to identify existing events in the electronic calendar based on the characteristics of the new event and the characteristics of the existing events;
in response to identifying at least one similar existing event, negotiate consolidation of the new event with the at least one similar existing event into a single consolidated event in the electronic calendar; and
store the consolidated event in the electronic calendar in place of at least one of the new event and the at least one similar existing event.

12. The computer program product of claim 11, wherein the new event is a meeting having as participants an originator of the new event and at least one invitee, and wherein performing a search of event characteristics to identify existing events is performed on electronic calendars on at least one computing device associated with each participant of the new event.

13. The computer program product of claim 12, wherein performing a search of event characteristics to identify existing events comprises at least one of sending a request, to computing devices associated with each participant in the new event from a computing device associated with the originator of the new event request, that each of the computing devices associated with each participant perform a search of event characteristics for existing events in a local electronic calendar data structure, or sending a request to a central server computing device requesting a search, of event characteristics for existing events, in participant calendar data structures maintained by the server computing device.

14. The computer program product of claim 11, wherein performing a search of event characteristics to identify existing events in the electronic calendar based on the characteristics of the new event and the characteristics of the existing events comprises:
identifying a first candidate set of existing events having a category characteristic matching a category characteristic of the new event; and
identifying a second candidate set of existing events from the first candidate set, the second candidate set of existing events having one or more tag characteristics matching one or more tag characteristics of the new event.

15. The computer program product of claim 14, wherein performing a search of event characteristics to identify existing events in the electronic calendar based on the characteristics of the new event and the characteristics of the existing events further comprises:
calculating a score for each of the existing events in the second candidate set of existing events based on a degree of matching for the one or more tag characteristics of the existing events to the one or more tag characteristics of the new event; and
identifying a highest scoring existing event as an existing event in the second candidate set having a highest score, wherein negotiating consolidation of the new event with the at least one similar existing event into a single consolidated event in the electronic calendar is performed with regard to the identified highest scoring existing event.

16. The computer program product of claim 11, wherein negotiating consolidation of the new event with the at least one similar existing event into a single consolidated event in the electronic calendar comprises:
providing an output to a user via a user interface, the output identifying the at least one similar existing event;
providing an output to the user via the user interface identifying one or more selectable options for selecting a process for performing the negotiation of consolidation of the new event with the at least one similar existing event;
receiving a user selection of an option in the one or more selectable options; and
performing the negotiation of the consolidation of the new event with the at least one similar existing event in accordance with the user selected option.

17. The computer program product of claim 11, wherein negotiating consolidation of the new event with the at least one similar existing event into a single consolidated event in the electronic calendar comprises:
sending a request to an originator of the at least one similar existing event requesting that participants in the new event be added as participants in the at least one similar existing event;
receiving a response from the originator of the at least one similar existing event; and
updating the characteristics of the new event to correspond with the characteristics of the at least one similar existing event if the originator of the at least one similar existing event accepts addition of the participants of the new event as participants in the at least one similar existing event.

18. The computer program product of claim 17, wherein negotiating consolidation of the new event with the at least one similar existing event into a single consolidated event in the electronic calendar further comprises:
scheduling the new event in response to the originator of the at least one similar existing event refusing addition of the participants of the new event as participants of the at least one similar event, wherein scheduling the new event as if the at least one similar existing event were not found in the search comprises determining a time and duration for the new event that is as close to the at least one similar existing event as possible given electronic calendar entries of the electronic calendars of the participants in the new event.

19. The computer program product of claim 11, wherein negotiating consolidation of the new event with the at least one similar existing event into a single consolidated event in the electronic calendar further comprises:
sending one or more requests to computing devices associated with one or more participants of the at least one similar existing event requesting a change in characteristics of the at least one similar existing event based on characteristics of the new event; and
updating characteristics of at least one of the new event or the at least one similar existing event based on responses received from computing devices associated with the one or more participants.

20. A system, comprising:
a processor; and
a memory coupled to the processor, wherein the memory comprises instructions which, when executed by the processor, cause the processor to:
receive a request to schedule a new event in the electronic calendar, wherein the request specifies characteristics of the new event, the characteristics being representative of content of the new event;
perform a search of event characteristics to identify existing events in the electronic calendar based on the characteristics of the new event and the characteristics of the existing events;
in response to identifying at least one similar existing event, negotiate consolidation of the new event with the at least one similar existing event into a single consolidated event in the electronic calendar; and
store the consolidated event in the electronic calendar in place of at least one of the new event and the at least one similar existing event.
